(19) United States
(12) Patent Application Publication
(10) Pub. No.: US 2026/0187472 A1
(43) Pub. Date: Jul. 2, 2026

(54) SYSTEMS AND METHODS FOR A REFLEX AGENT DESIGN PATTERN IN A MULTI-AGENT SYSTEM

(71) Applicant: Fidelity Information Services, LLC, Jacksonville, FL (US)

(72) Inventor: Ranadhir GHOSH, St. Johns, FL (US)

(73) Assignee: Fidelity Information Services, LLC, Jacksonville, FL (US)

(21) Appl. No.: 19/194,244

(22) Filed: Apr. 30, 2025

Related U.S. Application Data
(60) Provisional application No. 63/740,384, filed on Dec. 31, 2024.

(51) Int. Cl. G06N 3/092

(52) U.S. Cl. CPC G06N 3/092

(57) ABSTRACT

A method for implementing a multi-agent system to generate a response to a user query. The method may include receiving a query from a user; generating, by a response agent, an initial response to the query; evaluating, by a critic agent, a quality of the initial response, wherein evaluating the quality includes assigning, by the critic agent, a score to the initial response based on the quality; evaluating, by an ethical agent, ethical concerns in the initial response, wherein evaluating the ethical concerns includes determining, by the ethical agent, an evaluation report; determining, by a decision agent, that the initial response does not meet quality and ethical standards threshold values, instructing the response agent to improve the response.

### RELATED APPLICATION(S)

This application is a continuation of and claims the benefit of priority to U.S. Provisional Application No. 63/740,384 filed Dec. 31, 2024, the entire disclosure of which is hereby incorporated herein by reference in its entirety

### TECHNICAL FIELD

Various embodiments of the present disclosure relate generally to a multi-agentic system and, more particularly, to systems and methods for a reflex agent design pattern in multi-agent system.

### BACKGROUND

Traditional analytic platforms face scalability, adaptability, and integration issues in an Artificial Intelligence (“AI”) driven environment. Traditional analytic platforms may struggle to provide real-time data insight and may be slow to integrate updates for components within the platform.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a method for implementing a multi-agent system to generate a response to a user query, the method including: receiving a query from a user; generating, by a response agent, an initial response to the query; evaluating, by a critic agent, a quality of the initial response, wherein evaluating the quality includes assigning, by the critic agent, a score to the initial response based on the quality; evaluating, by an ethical agent, ethical concerns in the initial response, wherein evaluating the ethical concerns includes determining, by the ethical agent, an evaluation report; determining, by a decision agent, that the initial response does not meet quality and ethical standards threshold values, wherein the decision agent analyze the score generated by the critic agent to determine whether the initial response meets a quality standard threshold value, wherein the decision agent analyzes the evaluation report to determine whether the initial response meets an ethical standard threshold value; and instructing the response agent to improve the response.

In some aspects, the techniques described herein relate to a method, further including: determining, by the decision agent, that a recurring issue has occurred related to the query and activating a learning agent; designing, by the learning agent, a fine-tuning strategy for the response agent; and retraining the response agent based on the fine-tuning strategy.

In some aspects, the techniques described herein relate to a method, wherein the designing, by the learning agent, the fine-tuning strategy for the response agent further includes: generating simulated data to improve the response agent for specific topics related to the query.

In some aspects, the techniques described herein relate to a method, further including: determining, by the decision agent to incorporate a human feedback agent; and preparing, by the human feedback agent, a notification of detailed performance of the decision agent for a second user.

In some aspects, the techniques described herein relate to a method, further including: determining, by the decision agent, an urgency associated with the notification, the urgency being scored as either low urgency, medium urgency, or high urgency; wherein if the urgency is low urgency, the notification is an email, wherein if the urgency is medium urgency, the notification is a message through a messaging application, wherein if the urgency is high urgency, the notification is a phone call.

In some aspects, the techniques described herein relate to a method, further including: upon determining the initial response does not meet quality or ethic standard threshold values, generating, by the response agent, a second response to the query.

In some aspects, the techniques described herein relate to a method, further including: evaluating, by the critic agent, a second quality of the second response, wherein the critic agent assigns a second score to the second response; evaluating, by the ethical agent, ethical concerns in the second response, wherein the ethical agent determines a second evaluation report; determining, by the decision agent, that the second response meets quality and ethical standards threshold values, wherein the decision agent analyze the second score generated by the critic agent to determine whether the initial response meets the quality standard threshold value, wherein the decision agent analyzes the second evaluation report to determine whether the second response meets the ethical standard threshold value; and, outputting the second response to the user.

In some aspects, the techniques described herein relate to a method, further including: determining, by the decision agent, a topic associated with the query; and saving to a memory the response and corresponding quality score and evaluation report for the topic, wherein the memory is utilized by the decision agent to determine when to trigger a learning agent to retrain the response agent.

In some aspects, the techniques described herein relate to a method, wherein the response agent, critic agent, ethical agent, and decision agent are all separate large language models.

In some aspects, the techniques described herein relate to a multi-agent system configured to generate a response to a user query, the multi-agent system including: a first agent configured to generate a response to a user-provided prompt; a second agent configured to evaluate a quality of the response from the first agent; a third agent configured to analyze the response for ethical concerns; a fourth agent configured to evaluate outputs from the second agent and third agent; and a fifth agent configured to generate learning strategies and simulated training data to fine-tune the first agent.

In some aspects, the techniques described herein relate to a multi-agent system, wherein the second agent is configured to evaluate the quality of the response based on at least one of relevance, coherence, and overall performance of the response to the user-provided prompt.

In some aspects, the techniques described herein relate to a multi-agent system, wherein the third agent is configured to output a report based on the ethical concerns.

In some aspects, the techniques described herein relate to a multi-agent system, wherein the fourth agent is configured to track iterative performance memory topics and issue types received by the multi-agent system.

In some aspects, the techniques described herein relate to a multi-agent system, further including: a sixth agent configured to provide external intervention mechanisms when quality or ethical standards are not met after several iterations.

In some aspects, the techniques described herein relate to a method for implementing a multi-agent system to generate a response to a user query, the method including: receiving a query from a user; generating, by a response agent, an initial response to the query; evaluating, by a critic agent, a quality of the initial response, wherein evaluating the quality includes assigning, by the critic agent, a score to the initial response based on the quality; evaluating, by an ethical agent, ethical concerns in the initial response, wherein evaluating the ethical concerns includes determining, by the ethical agent, an evaluation report; determining, by a decision agent, that the initial response meets quality and ethical standards threshold values, wherein the decision agent analyze the score generated by the critic agent to determine whether the initial response meets a quality standard threshold value, wherein the decision agent analyzes the evaluation report to determine whether the initial response meets an ethical standard threshold value; and outputting the initial response to a user.

In some aspects, the techniques described herein relate to a method, further including: determining, by the decision agent to incorporate a human feedback agent; and preparing, by the human feedback agent, a notification of detailed performance of the decision agent for a second user.

In some aspects, the techniques described herein relate to a method, further including: determining, by the decision agent, an urgency associated with the notification, the urgency being scored as either low urgency, medium urgency, or high urgency; wherein if the urgency is low urgency, the notification is an email, wherein if the urgency is medium urgency, the notification is a message through a messaging application, wherein if the urgency is high urgency, the notification is a phone call.

In some aspects, the techniques described herein relate to a method, wherein the response agent, critic agent, ethical agent, and decision agent are all separate large language models.

In some aspects, the techniques described herein relate to a method, wherein evaluating, by the critic agent, the quality of the initial response and evaluating, by the ethical agent, ethical concerns in the initial response occurs simultaneously.

In some aspects, the techniques described herein relate to a method, wherein the query from a user relates to customer support case, a health care query, content moderation, or fraud detection

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1A depicts an exemplary environment for an AI-powered analytics platform, according to one or more embodiments.

FIG. 1B depicts an exemplary agent framework for the analytics platform of FIG. 1A, according to one or more embodiments.

FIG. 1C depicts an exemplary model loader for the analytics platform of FIG. 1A, according to one or more embodiments.

FIG. 1D depicts an exemplary set of agents in the agent framework for the analytics platform of FIG. 1A.

FIG. 2 depicts an exemplary flowchart for an exemplary workflow of a set of agents, according to one or more embodiments.

FIG. 3A depicts an exemplary method for implementing a multi-agent system to generate a response to a user query, according to one or more embodiments.

FIG. 3B depicts an exemplary method for implementing a multi-agent system to generate a response to a customer support case, according to one or more embodiments.

FIG. 3C depicts an exemplary method for implementing a multi-agent system to generate a response to a health care query, according to one or more embodiments.

FIG. 3D depicts an exemplary method for implementing a multi-agent system to generate content moderation, according to one or more embodiments.

FIG. 3E depicts an exemplary method for implementing a multi-agent system to generate fraud detection, according to one or more embodiments.

FIG. 4 illustrates a computer system for executing the techniques described herein, according to one or more embodiments of the present disclosure.

### DETAILED DESCRIPTION OF EMBODIMENTS

Various embodiments of the present disclosure relate generally to a multi-agentic system and, more particularly, to systems and methods for a reflex agent design pattern in multi-agent system

The subject matter of the present disclosure will now be described more fully with reference to the accompanying drawings that show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Traditional analytic platforms may face a variety of issues. For example, traditional analytic platforms may struggle with scalability, adaptability, and integration issues in an AI-driven environment. It may be challenging for an analytics platform to provide real-time insights. Further, it may be challenging to provide fast deployment for updated capabilities of the analytics platform. It may be challenging to provide a platform that is both scalable and adaptive. Exemplary implementations of the system may include payment fraud detection and loan validation as described in greater detail below.

Traditional analytics platforms may have technology stack diversity. This may include complex integration across infrastructure, data warehouses, processing, analytics, and AI modules. Traditional analytic platforms may have particular tools and frameworks that evolve continuously. Traditional analytics platforms may have scalability constraints, where traditional architectures struggle to scale effectively. Traditional analytic platforms may struggle to deliver new features to users quickly. Traditional analytic platforms may include infrastructure overheads with high costs and complexity in on-premises solutions. There may be a growing demand for superior analytics products across a variety of industries, including, but not limited to finance, healthcare, retail, etc. The environment described herein may incorporate a multi-agentic system (“MAS”) to address these issues.

Within a MAS, decentralized agents may need to collaborate effectively. Miscommunication or lack of synchronization between agents may lead to inefficiencies. For example, in a transportation system, poor coordination among agents can cause traffic congestion instead of resolving it.

Transparency of the system may be crucial to ensure decisions made by agents align with organizational and societal goals. For example, agents in healthcare applications must ensure privacy and ethical use of patient data.

MAS may be vulnerable to cyber threats like data breaches and system spoofing. The system described herein may implement robust encryption and multi-layered defenses that may be essential to secure communication between agents. Security enhancements, such as distributed consensus models may be incorporated which may improve MAS resilience to malicious attacks.

Scaling MAS may lead to resource bottlenecks, especially in data-heavy sectors like healthcare. The system described herein may implement cloud platforms like Azure and distributed processing systems (e.g., Hadoop) to overcome these issues.

The system described herein may incorporate tools, data, and models. The tools may include autonomous agents performing tasks based on inputs. Data may flow through the system, transforming from raw data to enriched knowledge. The models may include AI models supporting task execution and decision-making. The system may further incorporate decoupled modules enabling independent scaling and updates. The system may incorporate a MAS framework for task orchestrations.

The system described herein may be a cloud-based system that operates on servers hosted on the internet. By being cloud based, the system may have increased scalability to meet dynamic workloads. It may easily accommodate a comprehensive ecosystem for data, AI, and analytics. The system may be cost efficient, allowing for pay-as-you-go models that minimize upfront costs for users. Further, the system may include industry-leading standards for data security. In some examples, the system described herein may be uploaded through the Azure cloud environment.

The reflex agent design pattern in a Multi-Agent System (“MAS”) may be configured to create a modular and iterative approach to handle tasks by leveraging specialized agents. For example, each reflex agent (or other type of AI agent) may be configured to react to specific input receives without incorporating knowledge of broader context. The MAS described herein may include one or more reflex agents configured to interact with one another in a shared environment. The particular reflex agents may interact autonomously with one another. Each agent may perform a specific function, ensuring the system adapts and improves based on feedback from multiple perspectives such as quality, ethics, and iterative revisions. The system may include fallback mechanisms like human intervention and learning strategies for continuous improvement. An agent may refer to an autonomous entity such as a server or computing system within the MAS.

Some MAS may be increasingly complex as they handle diverse inputs, make critical decisions, and ensure quality and ethical compliance. Without a well-defined design pattern, such systems may risk being unscalable, difficult to maintain, and prone to errors. The system described herein my incorporate a design pattern such as the Reflex Agent to improve the following aspects of MAS: scalability and modularity, iterative improvement and adaption, risk mitigation and ethical compliance, human-AI collaboration, learning and long-term improvement

Scalability and modularity problems may include that in large-scale applications, adding or modifying functionality can lead to chaotic dependencies between components. The system described herein may incorporate a design pattern including a reflex agent that may ensure modularity, where agents are specialized for specific tasks (response generation, evaluation, decision-making, etc.). New agents may be added or updated independently without disrupting the system.

Iterative improvement and adaptation problems may include that static systems may fail to adapt to evolving requirements, particularly in quality, ethical standards, or domain-specific knowledge. The reflex design pattern incorporated by the system described herein may use iterative feedback loops to refine output and improve performance dynamically, ensuring continuous adaptation.

Risk mitigation and ethical compliance problems may include that poor responses or biased outputs can damage trust, violate regulations, or harm brand reputation. The system described herein may incorporate ethical and critic agents may evaluate output for compliance, ensuring responses align with quality and fairness expectations.

Human-AI collaboration problems may include that fully autonomous systems often lack oversight, leading to unchecked errors. The system described herein may integrate human feedback agents that may ensure that critical issues are escalated, enabling manual intervention when automation falls short.

Learning and long-term improvement may include how in some MAS systems there may be degradation over time if the MAS systems are not updated with new data or fail to handle recurring issues. The system described herein may incorporate learning agents that may ensure that the system evolves by generating tailored strategies and simulated data for continuous improvement.

The system described herein may incorporate a reflex agent design pattern that may be valuable for dynamic environments where decisions need to be quick and iteratively refined. Its architecture offers several key benefits such as responsiveness, error detection and iterative refinement, structured decision-making, adaptable and self-improving, and human oversight and trust.

The system described herein may be fast and responsive. For example, reflex agents may act immediately based on the current state (input prompts) and feedback from other agents. This may make reflex agents ideal for time-sensitive applications like customer support, decision-making systems, and real-time monitoring tools.

The system described herein may include error detection and iterative refinement. For example, by including critic and ethical agents, the design pattern may ensure some or every response is rigorously evaluated and refined to meet quality and ethical standards.

The system described herein may incorporate structured decision-making. For example, decision agents may serve as a centralized coordinator, ensuring that all feedback and evaluations are integrated into a structured process, reducing the chances of missed errors or poor decisions.

The system described herein may be adaptable and self-improving. For example, the reflex design pattern may go beyond static reflex actions by integrating learning mechanisms. It may use historical trends and recurring issues to improve the system's performance over time. This adaptability may be essential for systems handling complex and evolving datasets.

The system described herein may incorporate human oversight and trust. For example, automation may be balanced with human oversight through the human feedback agent, which may build trust in the system's reliability and ensuring accountability for critical decisions.

Advantageously, one or more embodiments may include improved output quality. The system may ensure high-quality, accurate responses with iterative refinement and robust evaluation. Advantageously, one or more embodiments may reduce risk of ethical violations or reputational damage by addressing biases and ethical concerns. Advantageously, one or more embodiments may be operational efficient, where the system may balance speed of automation with oversight mechanisms to ensure reliable results without excessive human intervention.

Advantageously, one or more embodiments may be scalable while having long term viability. The modular design described herein may support system expansion and long-term adaptability through learning agents and memory-driven improvements. Advantageously, one or more embodiments may have increased trust and accountability, where human feedback integration may ensure critical failures are addressed by experts, enhancing stakeholder confidence.

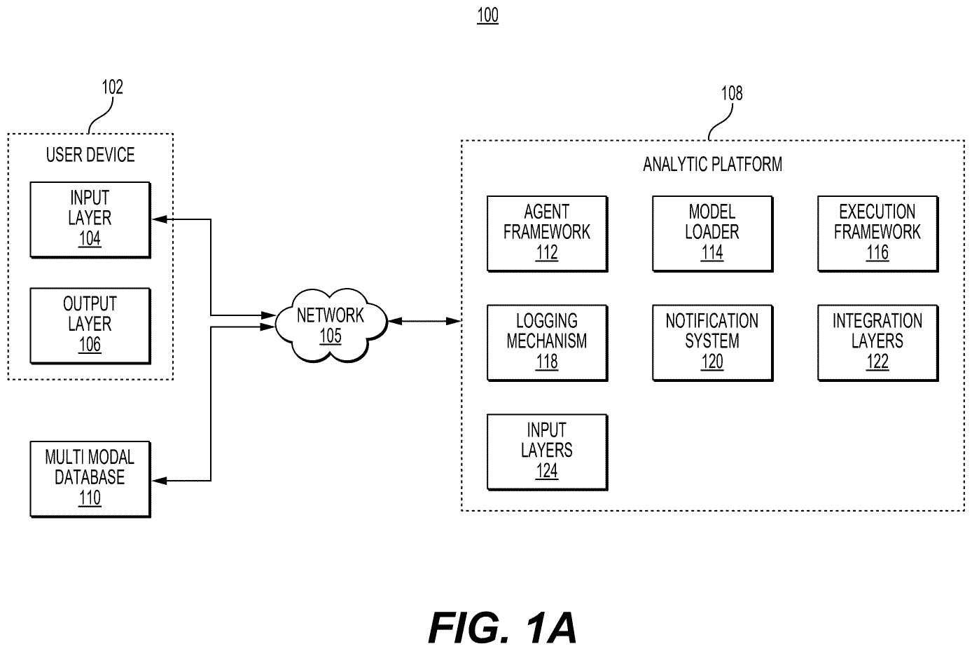

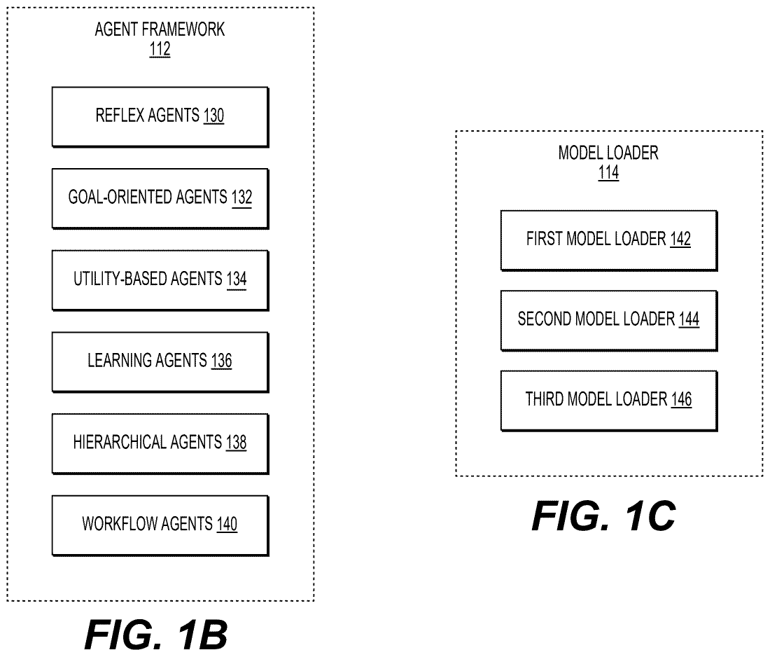

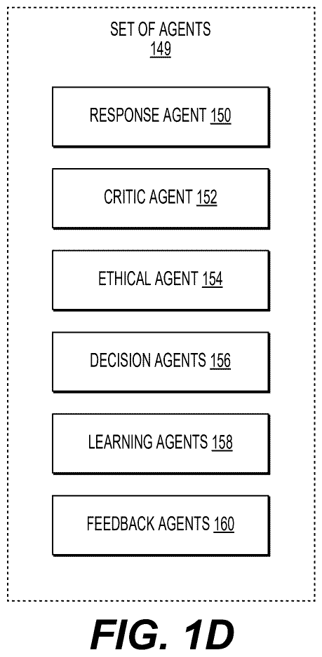

FIG. 1A depicts an exemplary environment 100 for an AI-powered analytics platform, according to one or more embodiments. The environment 100 may incorporate a multi-agentic system framework for task orchestration. Task orchestration may refer to the coordination, schedule, and management of multiple tasks or process across the system to achieve a desired goal. This may be achieved through the use of different components (e.g., AI agents) within the multi-agentic system. The environment 100 may include an analytics platform 108, a user device 102, and a Multi Modal database 110. The analytics platform 108, user device 102, and Multi Modal database 110 may be connected through a network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connections may be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in environment 100 to send and receive information between the components of environment 100.

The analytics platform 108 may be located in a cloud-based computing platform and may include an agent framework 112, a model loader 114, an execution framework 116, a logging mechanism 118, a notification system 120, and an integration layer 122. Each of these may be comprised of one or more software modules. The one or more software modules may be collections of code or instructions stored on a media (e.g., memory of organization computing system 400) that represent a series of machine instructions (e.g., program code) that implements one or more algorithmic steps. Such machine instructions may be the actual computer code, the processor of organization computing system 400 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions. In some examples, the one or more software modules may incorporate one or more AI agents as described in greater detail below. The AI agents may incorporate well-defined communication protocol such as protocol from the foundation of intelligent physical agents (“FIPA”) and may be configured to communicate with other AI agents.

The agent framework 112 may include one or more AI agents configured to execute particular tasks. An AI agent may refer to an autonomous, intelligent module configured to operate independently and to communicate and collaborate with one or more other agents. AI agents may be configured to execute particular tasks both asynchronously and/or synchronously. The various AI agents may be configured to enable predictive and/or prescriptive analytics. Each AI agent may include tools, data, and/or a machine learning model. The tools may be configured to retrieve/receive data and implement a model to perform a particular function.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity

The AI agents of the agent framework 112 may incorporate pre-trained large language models (“LLMs) as will be discussed in greater detail below. The AI agents in the agent framework 112 may be configured to retrieve inputs from application programming interfaces (“APIs”) (e.g., input from other agents or modules within the analytics platform 108), databases (e.g., Multi Modal database 110) and/or user devices 102. The AI agents of the agent framework 112 may be configured to execute actions and report results/outputs via one or more APIs. The AI agents may be triggered within particular workflows as described herein. A workflow, as will be described in greater detail below, may refer to a structured sequences of task, interactions, and decision-making processes for AI agents to perform in order to achieve a particular goal/outcomes. The workflow may include all AI agents necessary, the order at which AI agents to be applied, what metadata/outputs should each AI agent analyze, what historical data should be incorporated for each AI agent decision, and any dependencies that a particular AI agent may rely (e.g., a second AI agent may be configured to analyze an output for a first AI agent, and the second AI agent may not perform analysis until the first AI agent has completed the respective analysis). Each AI agent described herein may be configured to record and produce a log of each decision made. These logs may be transferred to and compiled within the logging mechanism 118 as described below.

FIG. 1B depicts an exemplary agent framework 112 for the analytics platform 108, according to one or more embodiments. The agent framework 112 may include one or more reflex agents 130, one or more goal-oriented agents 132, one or more utility-based agents 134, one or more learning agents 136, one or more hierarchical agents 138, and one or more workflow agents 140. The various agents may be configured to transform data into actionable insights. The agent framework 112 may be configured to receive additional AI agents and to retrain the AI agents overtime. Each of the AI agents may incorporate one or more machine learning systems to assist with the particular agent's goals.

The one more reflex agents 130 may be automated and utilized for rule-based repetitive tasks (e.g., for password resets). The one or more goal-oriented agents 132 may be for dynamic customer interactions (e.g., loan recommendations). For example, the goal-oriented agents 132 may incorporate one or more large language models to perform particular goals.

The one or more utility-based agents 134 may be agents configured to make decisions based on a utility function such as a mathematical model that ranks outcomes based on desirability. The one or more utility-based agents 134 may evaluate possible actions based on expected utility (e.g., may evaluate the performance of other agents).

The one or more learning agents 136 may be configured to design fine-tuning strategies and to generate simulated data for improving other agents for specific topics. The topic may define a type of user query (e.g., as financially related, customer support related, healthcare related, user-content, etc.). An issue type may refer to a subset of a particular category, for example an issue type may be fraud detection as a subset of the financially related topic. This may allow other agent types to have their AI models continuously trained and fined tuned. For example, the one or more learning agents may be utilized to improve fraud detection through past data analysis.

The one or more hierarchical agents 138 may be configured to divide and coordinate complex workflows (e.g., cross-border payments). The hierarchical agents 138 may have superior and subordinate relationships and may allow for decisions to flow downward or upward through hierarchy of agents. The one or more hierarchical agents 138 may allow for structuring decision-making control. For example, outputs of other agents may be transferred through one or more hierarchical agents 138 to the one or more workflow agents 140.

The one or more workflow agents 140 may handle task orchestration, process management and/or coordination between other agents. The one or more workflow agents 140 may essentially be managers of tasks, and responsible for ensuring a sequence of activities or actions occur. For example, the one or more workflow agents 140 may provide instructions so sequential and parallel execution of subtasks may occur across a workflow. The one or more workflow agents 140 may assist with automating sets of tasks across AI agents. The one or more workflow agents 140 may include fallback mechanism to address potential issues or failures of particular AI agents. The one or more workflow agents 140 may incorporate these dynamic fallback mechanisms in case of failure, and the fallback mechanism may be other AI agents configured to perform the task (e.g., based on predefined rules in the workflow).

The AI agents of the agent framework 112 may be fine-tuned on domain-specific data. In use, the AI agents may be provided detailed, constraint-based prompts to minimize hallucinations. For example, a prompt for a loan eligibility model may be to “Evaluate the following loan application. Provide a yes/no decision based only on the credit score and income criteria. Do not assume additional details.” In some examples, the AI agents may be containerized agents (e.g., Kubernetes), which may allow for high-volume processes such as fraud detection during peak transactions.

The analytics platform 108 may further include a model loader 114. The model loader 114 may be configured to load and initialize models (e.g., AI models) that the AI agents within the agent framework 112 utilize. The model loader 114 may assist with keeping the analytics platform 108 scalable and adaptable as it may allow for modularity and scalability, where different models can be added, removed, replaced, updated, without changing the core of the analytics platform 108. In some examples, the model loader 114 may be responsible for providing agents in the agent framework 112 with initial knowledge bases, goals, or domain-specific information. The model loader 114 may be configured to download or load models from online repositories of pre-trained models. The model loader 114 may further upload particular models from a user device 102 or external system.

FIG. 1C depicts an exemplary model loader 114 for the analytics platform 108, according to one or more embodiments. The model loader 114 may implement one or more software (e.g., Hugging Face) to access, load, and deploy various AI models (that may be implemented by the Agent framework 112). For example, the model loader 114 may load a first model 142 a second model 144 and a third model 146. In some examples, the model loader 114 may implement a transformers library to integrate with the respective models being loaded. In an example, the first model 142 may be Falcon, the second model 144 may be GPT-NeoX, and the third model 146 may be bloom software. One or more of these models may be loaded by agents depending on a respective task required of the AI agent. The first model 142 may be implemented for frequently asked questions. The second model 144 may be implemented for natural language processing tasks. The third model 146 may be implemented for multilingual analysis.

The analytics platform 108 may include an execution framework 116. The execution framework may ensure that tasks are completed in sequence or parallel with error handling. The execution framework 116 may include information on particular workflows. The execution framework 116 may store or have access to all uploaded workflows and may be configured to associate data objects with particular workflows. For example, this may include various use case scenarios of the analytics platform 108. Each workflow saved in the execution framework 116 may correspond to a particular set of analysis for various agents to perform, along with potential ordering of said AI agents performing their respective tasks. The execution framework 116 may receive additional rules-based setup for particular workflows from a user or separate database. This may include specific particular inputs (e.g., what data objects and respective metadata) initiate what particular workflow. Each workflow may further include specific output steps including what analysis to output and where to send the output. The execution framework 116 may be configured to receive particular workflows related to finance, health, transportation, etc. scenarios. In some examples, the execution framework 116 may be implemented by an AI agent (e.g., one or more workflow agents 140). The execution framework 116 may implement centralized monitoring systems to oversee agent interactions. For example, the execution framework may be configured to analyze the logging mechanism 118 described below to ensure analysis for particular workflows are completed accurately. The analytics platform 108 may include fault tolerance, where workflows include failover mechanisms. For example, workflows may include instructions where if an agent fails, its task may be rerouted to another instance. For example, Azure Event gride may be implemented to trigger retries when an agent outputs that an attempt was failed.

The analytics platform 108 may include a logging mechanism 118. The logging mechanism 118 may receive input from each AI agent of the agent framework 112 and record the respective input. For example, after performing an action, each of the AI agents may output a status to the logging mechanism 118. Each performed action/task may include a log task status such as success, retry, or error. Further, the logging mechanism may include detailed logs at every stage of a particular workflow. These logs may be in JavaScript Object Notation (“JSON”) format. The log may include agent decision, reasoning steps, and outcomes of each agent involved in the particular workflow. In some examples, the logging mechanism 118 may be implemented by Azure Cosmos DB or Databricks Delta Lakes. In some examples, the logging mechanism 118 may be connected to a dashboard configured to monitor workflow. The dashboard may be implemented by Power BI or Databricks SQL analytics. The dashboard may be accessible by one or more users (e.g., user device 102) or external servers and may visualize agent performance, flagged transactions, and/or workflow execution. An exemplary record in the logging mechanism 118 may be a log how the ‘Fraud Reflect Agent” flagged a transaction and what specific rules were triggers.

The analytics platform 108 may include a notification system 120. The notification system 120 may be configured to output one or more users to an external database (e.g., Multi Modal database 110) or to a user (e.g., through an input layer 104 of user device 102). For example, the notification system 120 may provide audit logs of the logging mechanism 118, decision rationales, and provide stakeholder reporting. The notification system 120 may be configured to perform regular audits of agent decision-making processes. The notification system 120 may allow for the determined insights to be shared with external systems and consumers. In some examples, the notification system 120 may be configured to collect all outputs from agents for a particular workflow and to compile the outputs. The notification system 120 may further validate and format an output for API responses or notifications to a user. These output formats may be predefined within the workflows within the execution framework 116.

The analytics platform 108 may include an integration layer 122 that may be implemented by the cloud computing service (e.g., by Databricks Data Ops or Azure Compute Ops). The integration layers 122 may incorporate software to allow for communication between all components of the analytics platform 108 and with external servers/users/databases. The integration layers may include REST APIs, and Pub/Sub messaging systems. In some examples, Kafka software may be implemented for the Pub/Sub messaging systems.

The analytics platform 108 may include input layers 124. The input layers 124 may be configured to receive raw data (e.g., receive one or more data objects, each of the data objects including metadata) from one or more users or external servers. In some examples, the input layers 124 may retrieve data via Azure Data Lake or Stream Analytics software. The input layers 124 may include one or more API to receive input via JSON. The input layers 124 may allow for data to be retrieved by the analytics platform 108, and based upon particular metadata, a particular workflow may be initiated to analyze the particular data object. For example, a data object intake could be a purchase for an item with a credit card. The metadata may include transaction information such as time, amount, location, object being purchased, etc.

A user device 102 (e.g., one or more user devices) may interact with the analytics platform 108 via network 105. The user device 102 may be operated by a user. For example, user device 102 may be a mobile device, a tablet, a desktop computer, or any computing system having the capabilities described herein. Users may include, but are not limited to, individuals such as, for example, subscribers, clients, prospective clients, or customers of an entity associated with the analytics platform 108.

The user device 102 may include an input layer 104 and an output layer 106. The input layer 104 may be configured to receive notification via the notification system 120 of the analytics platform 108. This may allow for the user device 102 to retrieve the results of various workflows performed by the analytics platform 108. The output layer 106 may allow for a user device 102 to upload a data object to the input layers 124 of the analytics platform 108. This may allow for particular devices to upload information to by analyzed by the analytic platform. For example, the user device 102 may be configured to automatically upload particular data objects and corresponding metadata upon the occurrence of a particular event. For example, each time a credit card is used, a server may upload a data object of the transaction with corresponding metadata for the analytics platform 108 to perform fraud detection.

In some examples, the user device 102 may require access control to access the analytics platform 108. For example, the analytics platform 108 may implement role-based access control (“RBAC”) by using software such as Azure Active Directory. The analytics platform 108 may further be configured to log all access attempts to sensitive data.

The user device 102 may include a graphic user interface (“GUI) for enabling interaction with the analytics platform 108. The outputs received by the user device 102 (e.g., by output layer 106) may include clear explanations for actions taken by particular agents, in addition to final decisions generated. In some examples (e.g., financial advisory use cases), the user device 102 may include recommendations in natural language and includes charts as justification. The user device 102 may allow for users to provide feedback on agent decisions. For example, a user may flag incorrect fraud alerts, which may be logged and used for model retraining.

The environment 100 may include a Multi Modal database 110. The Multi Modal database 110 may be configured to store logs from the logging mechanism 118. The Multi Modal database 110 may further store particular workflow outputs from the analytics platform 108. The Multi Modal database 110 may be accessed for auditing or by a user device 102.

The analytics platform 108 may implement secure APIs for communication. For example, the analytics platform 108 may enforce OAuth2 authentication and Hypertext Transfer Protocol Secure (“HTTPS”) for all API endpoints. The analytics platform 108 may implement rate limiting and anomaly detection to prevent abuse. In an example, workflow for fraud detection, each API implemented by included tokenized access.

The analytics platform 108 may implement adversarial defense techniques. This may include protecting models against adversarial attacks by: (1) regularly retraining on adversarial augmented datasets, and (2) by using adversary robust architecture or libraries such as IBM adversarial Robustness toolbox.

The analytics platform 108 may be configured to comply with regulations. This may include industry standards for handling user data such as General Data Protection Regulation (“GDPR”) and Payment Card Industry Data Security Standard (“PCI DSS”). For example, the platform may ensure that users can request their data deletion under GDPR.

The analytics platform 108 may include a distributed architecture. For example, the various modules, models and AI agents may be spread across a variety of servers through the cloud and network 105. The analytics platform 109 may deploy agents in a scalable environment such as Azure Kubernetes Service (“AKS”) to handle dynamic workloads. The analytics platform 109 may implement message brokers (e.g., RabbitMQ, Azure Service Bus) for asynchronous communication between agents. The analytics platform 108 may include monitoring and alert tools. For example, the analytics platform 108 may include tools such as Databricks Observability or Azure Monitor to track agent health and workflow execution. The analytics platform may be configured to set up alerts for anomalies such as sudden spikes in flagged transactions. The analytics platform 108 may be transparent and reliable and may implement software's such as Azure ML or Databricks to demonstrate model behavior. The analytics platform 108 may utilize cloud services such as Azure or AWS for distributed computations. The analytics platform 108 may implement modular designs where agents may be added or removed without disrupting the system. The analytics platform 108 may include one or more anomaly detection systems to identify potential threats. For example, one or more AI agents may be incorporated to detect unusual patterns in communication or outputs (e.g., sudden spike in flagged transactions).

The analytics platform 108 may implement security mechanisms such as data encryption and authentication. The data encryption may include encrypting all inter-agent communications. For example, the system may utilize transport layer security version 1.3, an encryption technique. Further, the analytics platform 108 may implement azure key value for secrets management. The analytics platform 108 may further incorporate OAuth2 for API calls, to ensure that only authorized apps and users may access data.

The analytics platform 108 may include a filtering mechanism to review outputs prior to sending them to a user device 102. For example, an AI agent may be applied to review and look for keyword analysis of any potential output. The analytics platform 108 may maintain documentation of all datasets and models implemented for traceability. The analytics platform 108 may regularly audit LLM behavior to ensure compliance with ethical norms (e.g., at set intervals of time).

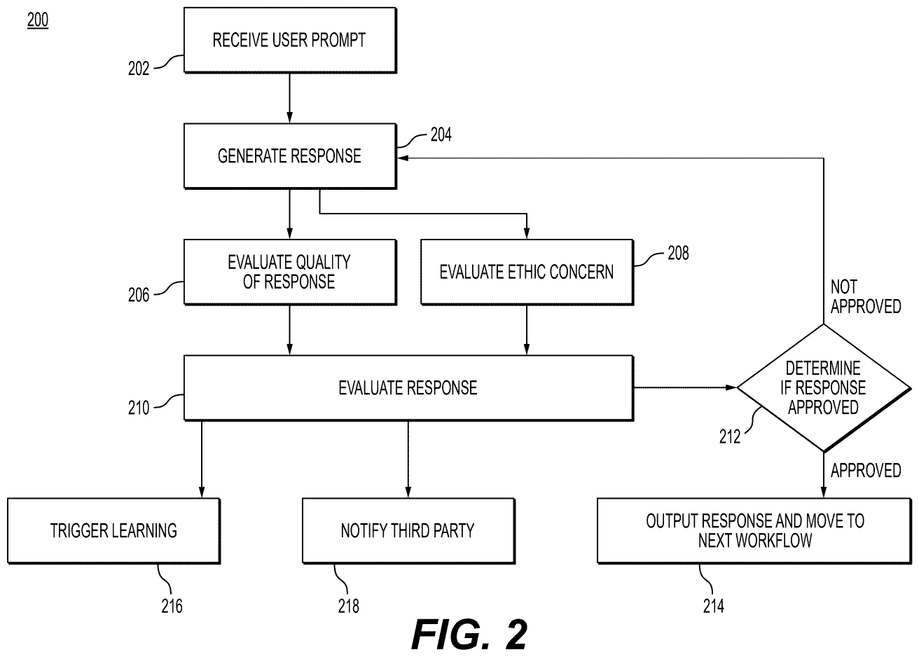

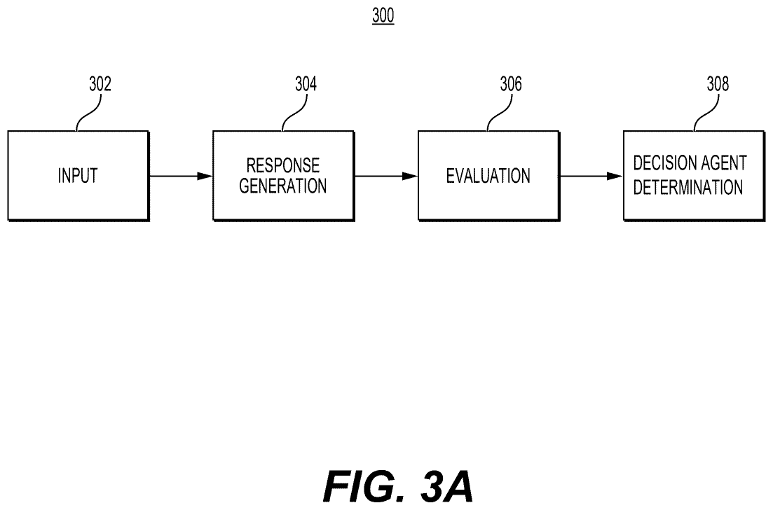

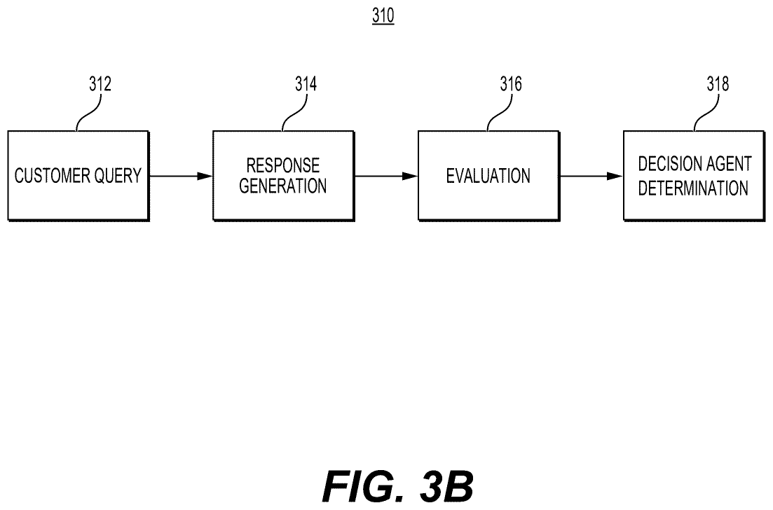

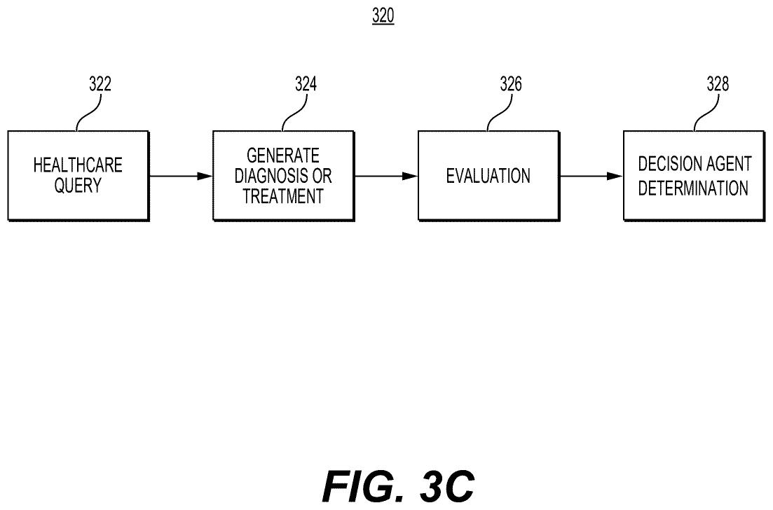

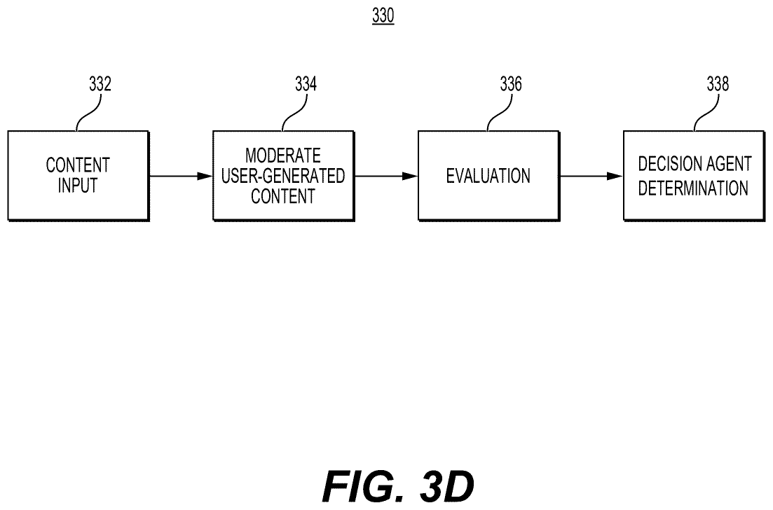

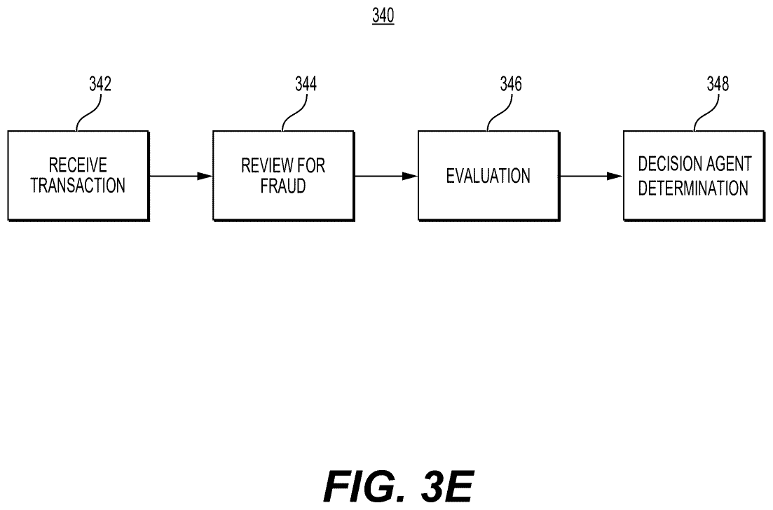

FIG. 1D depicts an exemplary set of agents 149 in the agent framework for the analytics platform of FIG. 1A. The set of agents 149 may be AI agents from the agent framework 112 as described in more detail below. These AI agents may represent a set of agents incorporated in the methods of FIG. 2 and FIG. 3A-3E. Each of the AI agents in the set of agents 149 may be configured to communicate with one another either directly (e.g., through direct messaging) or indirectly such as through shared resources or environmental changes.

The set of agents 149 may include a response agent 150, a critic agent 152, an ethical agent 154, a decision agent 156, a learning agent 158, and a feedback agent 160. Each of the set of agents 149 may incorporate a separate LLM. In some examples, each of the set of agent 149 may be reflex agents 130 of FIG. 1B. The response agent 150 may generate the initial and revised response to a user-provided prompt. The decision agent 156 may be an exemplary goal-oriented agent 132 of the agent framework 112. The response agent 150 may serve as the starting point for response creation. The response agent 150 may iteratively improve response based on feedback from other agents. Exemplary input that the response agent 150 may receive includes a prompt from the user or revised instructions from the decision agent 156. An exemplary output may be response text that may be evaluated by the critic agent 152 and the ethical agent 154.

The critic agent 152 may evaluate the quality of the response generated by the response agent 150 based on relevance, coherence, and overall performance. The decision agent 156 may be an exemplary goal-oriented agent 132 or reflex agent 130 of the agent framework 112. The critic agent 152 may provide a numerical score (e.g., 1-10 or another scoring scale) and detailed feedback for the generated response. Exemplary input that the critic agent 152 may receive includes a prompt and the corresponding response from the response agent, where the response requests an evaluation of the response. An exemplary output may be a quality score and feedback for the decision agent 156.

The ethical agent 154 may analyze the response from the response agent 150 for ethical concerns such as bias, offensive content, and/or discrimination. The decision agent 156 may be an exemplary goal-oriented agent 132 or reflex agent 130 of the agent framework 112. The ethical agent 154 may detect and categorize biases or confirm that a response is unbiased. Exemplary input that the response agent 150 may receive include a response from the response agent 150. An exemplary output may be an ethical evaluation report (e.g., bias type) to the decision agent 156. In some examples, an ethical score may be generated by the ethical agent 154. Biases may be detected in multiple different topics (e.g., gender roles, cultural differences, etc.).

The decision agent 156 may orchestrate the system workflow by processing evaluations from the critic agent 152 and ethical agent 154. The decision agent 156 may be an exemplary reflex agent 130, workflow agent 140, or hierarchical agent 138 of the agent framework 112. The decision agent 156 may decide next processing steps such as revising a response, proceeding to the next workflow, notifying a human, or triggering learning. The decision agent 156 may track iterative performance and memory for each topic and/or issue type. The decision agent 156 may maintain threshold for iterations and identifies recurring issues. Exemplary input that the decision agent 156 may receive includes evaluations from the critic agent 152 and ethical agent 154. The decision agent 156 may further receive iterative memory and topic-specific performance data. Exemplary outputs may include: (1) instructions to the response agent 150 to provide revisions, (2) notification to the human feedback agent 160 if intervention is required, and/or (3) problematic topic data to the learning agent 158 if recurring issues are detected.

The feedback agent 160 may provide a human intervention mechanism when the system fails to meet quality or ethical standards after several iterations. For example, this may occur after three iterations resulting in unsuccessful responses as determined by the decision agent 156. The feedback agent 160 may be an exemplary reflex agent 130 or workflow agent 140 of the agent framework 112. The feedback agent 160 may format detailed performance reports into notifications sent to humans via email, phone, or messaging platforms. The human feedback agent may ensure urgent cases are escalated appropriately. Exemplary input that the feedback agent 160 may receive include detailed response from the decision agent 156. Exemplary outputs may include human-readable notification for intervention which may be sent to one or more user devices (e.g., user device 102).

The learning agent 158 may generate learning strategies and simulated training data to fine tune the response agent 150. The learning agent 158 may be an exemplary reflex agent 130 or learning agent 136 from the agent framework 112. The learning agent 158 may analyze problematic topics and recurring biases to create tailored learning instructions and realistic examples for fine-tuning. The learning agent 158 may create training data and strategies for implementing the training data to train an AI agent (e.g., an AI agent of the decision agent 156). Exemplary input that the learning agent 158 may receive includes problematic topic data from the decision agent 156. Exemplary outputs may include detailed learning strategies and simulated training data. The learning agent 158 may be triggered by the decision agent 156 upon the occurrence of reoccurring issues for a particular topic.

FIG. 2 depicts an exemplary flowchart for an exemplary workflow 200 of a set of agents, according to one or more embodiments. The workflow 200 described in FIG. 2 may be a general description of how the agents described herein (e.g., the set of agents 149) are connected.

The flowchart of FIG. 2 may depict a workflow 200 of a use case of the environment 100. The first step 202 of a use case may be for the analytic platform 108 to receives a user prompt (e.g., by user device 102). The user prompt may include a user question (e.g., a customer query), a healthcare related input (e.g., symptoms of a patient), user generated content (e.g., a potential post to a social media account), a financial transaction (e.g., a credit card transaction).

At step 204, the response agent (e.g., response agent 150) may generate a response to the user response. This response may be generated by an LLM within the response agent. The generated response may then be output to a critic agent (e.g., critic agent 152) and an ethical agent (e.g., ethical agent 154).

At step 206, a critic agent (e.g., critic agent 152) may evaluate the quality of the response generated at step 204. This may include evaluating the quality of the generated response to assign a score and providing feedback for the generated response. The score and feedback may then be output to a decision agent (e.g., decision agent 156).

At step 208, an ethical agent (e.g., ethical agent 154) may evaluate the ethical response for ethical concerns. This may include implementing an LLM model to evaluate the response for ethic concerns. This may include detecting and categorizing biases. This may be output in an evaluation report. The detected and categorized biases may then be output to a decision agent (e.g., decision agent 156) through the evaluation report.

At step 210, the decision agent (e.g., decision agent 156) may consolidate the evaluation from the critic agent and ethical agent and evaluate the response. Evaluating the response may include decided whether to (1) approve the response, (2) instruct the response agent to improve the response, (3), trigger learning, and/or (4) notify a human feedback agent.

First, at step 212, the decision agent may determine if a response is an approved response. This may include determining whether the ethical agent evaluation report meets an ethical standard threshold value, and that the critic agent's quality score is within a threshold value. At step 214, If both the evaluation report and quality score are within a threshold value, then the environment may output a response and move onto the next workflow. If either the evaluation report or quality score is not within a threshold value, then a prompt may be sent back to the response agent to generate a new response. The prompt may include aspects of the initial response that need improvement and may include the ethical agent evaluation report and critic agent's quality score. This may start another iteration of steps 204-0212.

At step 216, the decision agent may decide to trigger learning of the response agent from step 204. For example, if recurring issues are identified, the decision agent may prepare and send a request to a learning agent (e.g., learning agent 158) to design a fine-tuning strategy and generate simulated data to improve the response agent for specific topics. The learning agent may be configured to utilize the training plan and training data to train the decision agent. This may occur prior to the decision agent generating a second response.

At step 218, the decision agent may decide to notify a feedback agent (e.g., a feedback agent 160) to escalate the response. The feedback agent may prepare a notification with detailed performance reports and send it to one or more external servers via an appropriate medium. This may allow for a human to access and review the prepared response.

FIG. 3A depicts an exemplary method for implementing a multi-agent system to generate a response to a user query, according to one or more embodiments. The method 300 described in FIG. 3A may be implemented by the environment 100 described in FIG. 1A-1D. The method 300 may be a general description of how the environment 100 applies the analytics platform 108 for generating an exemplary response.

Step 302 may include receiving (e.g., within the analytic platform 108) an input such as a query from a user (e.g., from user device 102). The input may include a user question (e.g., a customer query), a healthcare related input (e.g., symptoms of a patient), user generated content (e.g., a potential post to a social media account), a financial transaction (e.g., a credit card transaction).

Step 304 may include generating, by a response agent (e.g., response agent 150) an initial response to the query. This may include generating the response with an LLM within the response agent. In some examples, the response may be an approval/denial of an input (for example, approval/denial of a transaction or potential content). In this scenario, the received query may be assigned a score, and the response generation may provide a description of why a score is assigned to the input of step 302. In some example, the generated response may be a textual output, such as a response to a question.

Step 306 may include evaluating the response generated at step 304. This may include evaluating, by a critic agent (e.g., critic agent 152), a quality of the initial response, wherein the critic agent assigns a score to the initial response based on the quality.

The method may further include evaluating, by an ethical agent (e.g., ethical agent 154), ethical concerns in the initial response, where the ethical agent determines an evaluation report. The evaluation report may be a written report describing any ethical concerns related to the generated response such as detecting any bias in the response. The quality of the initial response and the ethical concerns of the response may be performed simultaneously.

Step 308 may include determining, by a decision agent (e.g., decision agent 156), whether the initial response meets quality and ethical standard threshold values. The decision agent may analyze the score generated by critic agent to determine whether the initial response meets a quality standard threshold value. The decision agent may analyze the evaluation report to determine whether the initial response meets an ethical standard threshold value. The decision agent may generate an ethics score for the evaluation report to determine if the response meets the ethical standard threshold value, where the ethic score must be within the ethical standard threshold value to be approved.

The method 300 may include, determining, by the decision agent, a topic associated with the query. The topic may define a type of user query (e.g., as financially related, customer support related, healthcare related, user-content, etc.). The method may further include saving to a memory the response and corresponding quality score and evaluation report for the topic, wherein the memory is utilized by the decision agent to determine when to trigger a learning agent to retrain the response agent. In some examples, the decision agent may track how many iterations occur for each input received at step 302. In some examples, the decision agent may track every response generated that is associated with a particular transaction.

The method 300 may further include determining, by the decision agent, that a recurring issue has occurred related to the query and activating a learning agent (learning agent 158); designing, by the learning agent, a fine-tuning strategy for the response agent; and retraining the response agent based on the fine-tuning strategy. Designing the fine-tuning strategy may include generating simulated data to improve the response agent for specific topics related to the query. In some examples, the learning agent may generate a strategy to address biases with simulated data for fine-tuning (e.g., when a generate response for a topic repeatedly has ethical concerns).

The method 300 may include determining, by the decision agent to incorporate a human feedback agent (e.g., feedback agent 160); and preparing, by the human feedback agent, a notification of detailed performance of the decision agent for a second user. This may further include, determining, by the decision agent, an urgency associated with the notification, the urgency being scored as either low urgency, medium urgency, or high urgency; wherein if the urgency is low urgency, the notification is an email, wherein if the urgency is medium urgency, the notification is a message through a messaging application, wherein if the urgency is high urgency, the notification is a phone call.

Step 308 may further include, upon determining whether the initial response does not meet quality or ethic standard threshold values, instructing the response agent to improve the response. This may include, generating, by the response agent (e.g., response agent 150), a second response to the query. This may be performed by providing the response agent with a prompt to improve the response, wherein the prompt may include outputs from the critic agent and ethical agent and instructions to generate the second response to improve upon the first response based on the critic agent and ethic agent outputs.

If a second response is generated, the method may further include applying step 306 to the second response. This may include evaluating, by the critic agent, a second quality of the second response, wherein the critic agent assigns a second score to the second response; evaluating, by the ethical agent, ethical concerns in the second response, wherein the ethical agent determines a second evaluation report; and determining, by the decision agent, whether the second response meets quality and ethical standards threshold values, wherein the decision agent analyze the second score generated by the critic agent to determine whether the initial response meets the quality standard threshold value, wherein the decision agent analyzes the second evaluation report to determine whether the second response meets the ethical standard threshold value.

Alternatively, step 308 may include that upon determining the initial response does meet quality and ethic standard threshold values, outputting the initial response to the user (e.g., via user device 102). Each of the response agent, critic agent, ethical agent, and decision agent may all incorporate separate large language models (“LLMs”).

FIG. 3B-3E may describe a few embodiments of the method 300 for FIG. 3A. These embodiments may describe specific use cases of the method 300 and may be implemented by the environment 100 described in FIG. 1A-1D.

FIG. 3B depicts an exemplary method 310 for implementing a multi-agent system to generate a response to a customer support case, according to one or more embodiments. Step 312 may incorporate step 302 and may include receiving a customer query from a user (e.g., from user device 102) as input. An exemplary input may be “how do renew my subscription for product x.” Step 314 may incorporate step 304 to generate a response for customer support. For example, this may be a response for how to renew a subscription. Step 316 may incorporate step 306. Step 318 may incorporate step 308. The method may generate a response to customer queries (from step 302) while maintaining high accuracy and avoiding biases (e.g., cultural or gender). Without iterative feedback and oversight, other systems may deliver poor or inappropriate responses. By using reflex agents (e.g., response agent 150), the method may be implemented quickly, while ensuring quality and compliance through the critic and ethical agent. Further, the method 310 may allow for human intervention to be triggered for critical cases.

FIG. 3C depicts an exemplary method 320 for implementing a multi-agent system to generate a response to a health care query, according to one or more embodiments. Step 322 may incorporate step 302 and may include receiving a health care query from a user (e.g., from user device 102) as input. The input may include a list of symptoms and a request for diagnosis or treatment. Step 324 may incorporate step 304 to generate a response for health care query. For example, this may be a response that includes a diagnosis or treatment recommendations. Step 326 may incorporate step 306. Step 328 may incorporate step 308. The method 320 may implement an AI system to generate diagnoses or treatment recommendations. As errors or biases in the system could result in life-threatening outcomes, the method may incorporate checks on biases and responses. The method 320 may implement reflex agents to ensure immediate action on patient data. The method 320 may further incorporate iterative feedback loops that may refine recommendations based on clinical guidelines. The method 320 may further allow for human agents to review cases flagged as high-risk.

FIG. 3D depicts an exemplary method 330 for implementing a multi-agent system to generate content moderation, according to one or more embodiments. Step 332 may incorporate step 302 and may include receiving a content input from a user (e.g., from user device 102) as input. This may include a request for a potential post (e.g., text and/or image) related to a particular subject. In some examples, a potential post may be uploaded directly. Step 334 may incorporate step 304 to determine whether content needs to be flagged/approved. For example, this may be a content may be approved as user friendly. Step 336 may incorporate step 306. Step 338 may incorporate step 308. The method 330 may be utilized to automatically moderate user-generated content for offensive language, hate speech, or misinformation. Previous systems may over-flag or under-flag content without proper calibration. The method 330 may implement reflex agents to provide instant moderation, where ethical agents may identify specific biases or harmful patterns, and learning agents may create simulated content for fine-tuning moderation algorithms.

FIG. 3E depicts an exemplary method 340 for implementing a multi-agent system to generate fraud detection, according to one or more embodiments. Step 342 may incorporate step 302 and may include receiving a financial transaction from a user (e.g., from user device 102) as input. Step 344 may incorporate step 304 to review a financial transaction. For example, this may be detecting fraudulent transactions in real-time. Step 346 may incorporate step 306. Step 348 may incorporate step 308. The method 320 may incorporate reflex agents to flag transactions based on initial criteria, where critic agents may evaluate accuracy, and the decision agent may escalate persistent issues to human reviewers and trigger learning agents for system improvement. This may overcome the challenge of false positive and negatives that may lead to either missed fraud or unnecessary disruption to customers.

In an exemplary use case of the method 300, the method may evaluate a biased response. At step 302, an input prompt may be received stating “write a statement about gender roles.” At step 304, the response agent may generate an initial response. At step 306, the critic agent may score the response as 5/10 based on poor coherence, and the ethical agent may detect gender bias. At step 308, the decision agent may request that the response be revised and send a request to the response agent to generate a second response based on the feedback. This may initiate a second iteration of the method 300, where at step 304 the response agent may generate a revised response. At the step 306, the critic agent may score the response as 6/10, and the ethic agent may still detect subtle bias. At step 308, the decision agent may request that the response be reviewed and send a request to the response agent to generate a third response based on the feedback. This may initiate a third iteration of the method 300, where at step 304, the response agent may generate a third response. At step 306, the critic agent may again assign a score of 6/10 and the ethic agent may still detect bias. At step 308, the decision agent may determine that the response still fails to meet appropriate threshold values. The decision agent may then send a detailed report to a human feedback agent, where a human feedback agent may format and send a phone notification for human intervention.

The systems and methods described herein may incorporate a reflex agent design pattern that may ensure a robust and modular approach to multi-agent systems, by incorporating evaluation, revision, escalation, and learning mechanisms. By combining automation and human feedback, Reflex Agent Design Pattern may achieve adaptive and ethical performance in complex workflows.

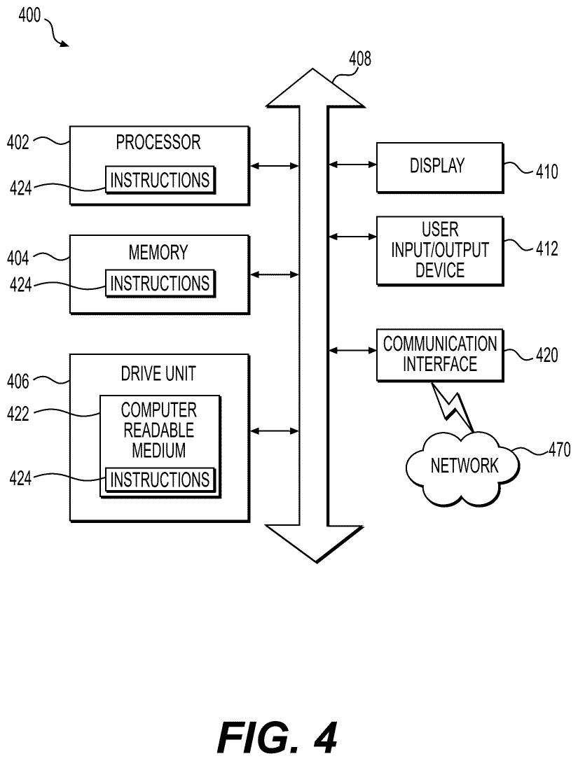

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 includes a cache or random-access memory for the processor 402. In alternative implementations, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions stored in the memory 404. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel payment and the like.

As shown, the computer system 400 may further include a display unit 410, such as a liquid crystal display (LCD), an organic light emitting diode (OLED), a flat panel display, a solid-state display, a cathode ray tube (CRT), a projector, a printer or other now known or later developed display device for outputting determined information. The display unit 410 may act as an interface for the user to see the functioning of the processor 402, or specifically as an interface with the software stored in the memory 404 or in a disc or optical drive unit 406.

Additionally, or alternatively, the computer system 400 may include an input/output device 412 configured to allow a user to interact with any of the components of computer system 400. The input/output device 412 may be a number pad, a keyboard, or a cursor control device, such as a mouse, or a joystick, touch screen display, remote control, or any other device operative to interact with the computer system 400.

The drive unit 406 may include a computer-readable medium 422 in which one or more sets of instructions 424, e.g., software, can be embedded. Further, the instructions 424 may embody one or more of the methods or logic as described herein. The instructions 424 may reside completely or partially within the memory 404 and/or within the processor 402 during execution by the computer system 400. The memory 404 and the processor 402 also may include computer-readable media as discussed above.

In some systems, a computer-readable medium 422 includes instructions 424 or receives and executes instructions 424 responsive to a propagated signal so that a device connected to a network 470 can communicate voice, video, audio, images, or any other data over the network 470. Further, the instructions 424 may be transmitted or received over the network 470 via a communication port or interface 420, and/or using a bus 408. The communication port or interface 420 may be a part of the processor 402 or may be a separate component. The communication port 420 may be created in software or may be a physical connection in hardware. The communication port 420 may be configured to connect with a network 470, external media, the display unit 410, or any other components in computer system 400, or combinations thereof. The connection with the network 470 may be a physical connection, such as a wired Ethernet connection or may be established wirelessly as discussed below. Likewise, the additional connections with other components of the computer system 400 may be physical connections or may be established wirelessly. The network 470 may be directly connected to the bus 408.

While the computer-readable medium 422 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 422 may be non-transitory and may be tangible.

The computer-readable medium 422 can include a solid-state memory such as a memory card or other package that houses one or more non-volatile read-only memories. The computer-readable medium 422 can be a random-access memory or other volatile re-writable memory. Additionally, or alternatively, the computer-readable medium 422 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 400 may be connected to one or more networks 470. The network 470 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including but not limited to TCP/IP based networking protocols. The network 470 may include wide area networks (WAN), such as the Internet, local area networks (LAN), campus area networks, metropolitan area networks, a direct connection such as through a Universal Serial Bus (USB) port, or any other networks that may allow for data communication. The network 470 may be configured to couple one computing device to another computing device to enable communication of data between the devices. The network 470 may generally be enabled to employ any form of machine-readable media for communicating information from one device to another. The network 470 may include communication methods by which information may travel between computing devices. The network 470 may be divided into sub-networks. The sub-networks may allow access to all of the other components connected thereto or the sub-networks may restrict access between the components. The network 470 may be regarded as a public or private network connection and may include, for example, a virtual private network or an encryption or other security mechanism employed over the public Internet, or the like. In some examples, network 470 may be network 105 of FIG. 1A.

In accordance with various implementations of the present disclosure, the methods described herein may be implemented by software programs executable by a computer system. Further, in an exemplary, non-limited implementation, implementations can include distributed processing, component/object distributed processing, and parallel payment. Alternatively, virtual computer system processing can be constructed to implement one or more of the methods or functionalities as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP, etc.) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosed embodiments are not limited to any particular implementation or programming technique and that the disclosed embodiments may be implemented using any appropriate techniques for implementing the functionality described herein. The disclosed embodiments are not limited to any particular programming language or operating system.

It should be appreciated that in the above description of exemplary embodiments, various features of the embodiments are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that a claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some, but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the function.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A method for implementing a multi-agent system to generate a response to a user query, the method including:
receiving a query from a user;
generating, by a response agent, an initial response to the query;
evaluating, by a critic agent, a quality of the initial response, wherein evaluating the quality includes assigning, by the critic agent, a score to the initial response based on the quality;
evaluating, by an ethical agent, ethical concerns in the initial response, wherein evaluating the ethical concerns includes determining, by the ethical agent, an evaluation report;
determining, by a decision agent, that the initial response does not meet quality and ethical standards threshold values, wherein the decision agent analyze the score generated by the critic agent to determine whether the initial response meets a quality standard threshold value, wherein the decision agent analyzes the evaluation report to determine whether the initial response meets an ethical standard threshold value; and
instructing the response agent to improve the response.

2. The method of claim 1, further including:
determining, by the decision agent, that a recurring issue has occurred related to the query and activating a learning agent;
designing, by the learning agent, a fine-tuning strategy for the response agent; and
retraining the response agent based on the fine-tuning strategy.

3. The method of claim 2, wherein the designing, by the learning agent, the fine-tuning strategy for the response agent further includes:
generating simulated data to improve the response agent for specific topics related to the query.

4. The method of claim 1, further including:
determining, by the decision agent to incorporate a human feedback agent; and
preparing, by the human feedback agent, a notification of detailed performance of the decision agent for a second user.

5. The method of claim 4, further including:
determining, by the decision agent, an urgency associated with the notification, the urgency being scored as either low urgency, medium urgency, or high urgency;
wherein if the urgency is low urgency, the notification is an email, wherein if the urgency is medium urgency, the notification is a message through a messaging application, wherein if the urgency is high urgency, the notification is a phone call.

6. The method of claim 1, further including:
upon determining the initial response does not meet quality or ethic standard threshold values, generating, by the response agent, a second response to the query.

7. The method of claim 6, further including:
evaluating, by the critic agent, a second quality of the second response, wherein the critic agent assigns a second score to the second response;
evaluating, by the ethical agent, ethical concerns in the second response, wherein the ethical agent determines a second evaluation report; and
determining, by the decision agent, that the second response meets quality and ethical standards threshold values, wherein the decision agent analyze the second score generated by the critic agent to determine whether the initial response meets the quality standard threshold value, wherein the decision agent analyzes the second evaluation report to determine whether the second response meets the ethical standard threshold value; and, outputting the second response to the user.

8. The method of claim 1, further including:
determining, by the decision agent, a topic associated with the query; and
saving to a memory the response and corresponding quality score and evaluation report for the topic, wherein the memory is utilized by the decision agent to determine when to trigger a learning agent to retrain the response agent.

9. The method of claim 1, wherein the response agent, critic agent, ethical agent, and decision agent are all separate large language models.

10. A multi-agent system configured to generate a response to a user query, the multi-agent system including:
a first agent configured to generate a response to a user-provided prompt;
a second agent configured to evaluate a quality of the response from the first agent;
a third agent configured to analyze the response for ethical concerns;
a fourth agent configured to evaluate outputs from the second agent and third agent; and
a fifth agent configured to generate learning strategies and simulated training data to fine-tune the first agent.

11. The multi-agent system of claim 10, wherein the second agent is configured to evaluate the quality of the response based on at least one of relevance, coherence, and overall performance of the response to the user-provided prompt.

12. The multi-agent system of claim 10, wherein the third agent is configured to output a report based on the ethical concerns.

13. The multi-agent system of claim 10, wherein the fourth agent is configured to track iterative performance memory topics and issue types received by the multi-agent system.

14. The multi-agent system of claim 10, further including:
a sixth agent configured to provide external intervention mechanisms when quality or ethical standards are not met after several iterations.

15. A method for implementing a multi-agent system to generate a response to a user query, the method including:
receiving a query from a user;
generating, by a response agent, an initial response to the query;
evaluating, by a critic agent, a quality of the initial response, wherein evaluating the quality includes assigning, by the critic agent, a score to the initial response based on the quality;
evaluating, by an ethical agent, ethical concerns in the initial response, wherein evaluating the ethical concerns includes determining, by the ethical agent, an evaluation report;
determining, by a decision agent, that the initial response meets quality and ethical standards threshold values, wherein the decision agent analyze the score generated by the critic agent to determine whether the initial response meets a quality standard threshold value, wherein the decision agent analyzes the evaluation report to determine whether the initial response meets an ethical standard threshold value; and
outputting the initial response to a user.

16. The method of claim 15, further including:
determining, by the decision agent to incorporate a human feedback agent; and
preparing, by the human feedback agent, a notification of detailed performance of the decision agent for a second user.

17. The method of claim 16, further including:
determining, by the decision agent, an urgency associated with the notification, the urgency being scored as either low urgency, medium urgency, or high urgency;
wherein if the urgency is low urgency, the notification is an email, wherein if the urgency is medium urgency, the notification is a message through a messaging application, wherein if the urgency is high urgency, the notification is a phone call.

18. The method of claim 15, wherein the response agent, critic agent, ethical agent, and decision agent are all separate large language models.

19. The method of claim 15, wherein evaluating, by the critic agent, the quality of the initial response and evaluating, by the ethical agent, ethical concerns in the initial response occurs simultaneously.

20. The method of claim 15, wherein the query from a user relates to customer support case, a health care query, content moderation, or fraud detection.
